(19) United States
(12) Patent Application Publication
(10) Pub. No.: US 2026/0232096 A1
(43) Pub. Date: Aug. 13, 2026

(54) NAIL CLIPPER

(71) Applicant: KAI R&D CENTER CO., LTD., Gifu (JP)

(72) Inventors: Teruyoshi KURIBAYASHI, Seki-shi (JP); Takahito TOMINAGA, Seki-shi (JP)

(73) Assignee: KAI R&D CENTER CO., LTD., Gifu (JP)

(21) Appl. No.: 19/152,661

(22) PCT Filed: Jan. 19, 2024
(86) PCT No.: PCT/JP2024/001465

§ 371 Date: Jul. 31, 2025

(30) Foreign Application Priority Data
Mar. 16, 2023 (JP) 2023-042344

(51) Int. Cl. A45D 29/02

(52) U.S. Cl. CPC A45D 29/02

(57) ABSTRACT

A nail clipper according to the present invention includes: a first blade body (10) including a first blade-edged part (13) at a first tip part (12) located at a tip portion; a second blade body (20) including a second blade-edged part (23) at a second tip part (22) located at a tip portion; and an operating member (30) for operating the first blade-edged part and the second blade-edged part to approach and separate from each other. The first tip part (12) includes a blade front (15) exposed to the outside and a blade back (16) located on the back side of the blade front. The blade back (16) is curved such that an angle with respect to a vertical direction increases with distance from a blade edge at the tip of the first blade-edged part, and an angle formed by the blade front and the blade back is 20° or more and 35° or less at the blade edge of the first blade-edged part.

### TECHNICAL FIELD

One aspect of the present invention relates to a nail clipper.

### BACKGROUND ART

Conventionally, there has been a nail clipper as described in Patent Literature 1 or 2. In the nail clipper described in Patent Literature 1, in a state where an upper blade edge and a lower blade edge face each other, a support part of an upper operating lever and a support part of a lower operating lever are inserted between upper and lower blade bodies through support holes thereof, and are rotatably supported to each other between the upper and lower blade bodies by a rotation coupling part. A force-applying point part of the upper operating lever is located between the upper and lower blade edges and the rotation coupling part, and is engaged with the outside of the support hole by the lower blade body. A force-applying point part of the upper operating lever is located between the upper and lower blade edges and the rotation coupling part, and is engaged with the outside of the support hole by the upper blade body.

The nail clipper described in Patent Literature 2 includes a support. A cutting member is disposed in the support. A cutting blade is formed at a front end of the cutting member, and the cutting blade side has elasticity in a direction away from each other. A support shaft is inserted through front end parts of the support and the cutting member. A pressing operating lever is rotatably supported to an upper end part of the support shaft. The cutting member is supported with respect to the support shaft so as to be rotatable in a clockwise direction and a counterclockwise direction about an axial center of the support shaft as a rotation center. When the nail clipper is used, a part of the cutting member protruding from a cutout surface is pulled out.

### CITATION LIST

### Patent Literature

Patent Literature 1: JP 2002-248013 A

Patent Literature 2: JP 2018-102408 A

### SUMMARY OF INVENTION

### Technical Problem

There is a continuous need for nail clippers that improve sharpness, reduce cutting resistance, and cut nails smoothly and cleanly. In the nail clipper described in Patent Literature 1 or 2, there is room for improvement from the viewpoint of smoothly and cleanly cutting nails. In order to improve the sharpness of the nail clipper, it is conceivable to make a blade edge sharp, but when the blade edge is simply made thin to make the blade edge sharp, a blade body may be warped or broken.

In addition, from the viewpoint of 12.5 “By 2030, substantially reduce waste generation through prevention, reduction, recycling and reuse.” in the “Responsible Production and Consumption” of SDGs Goal 12, there is an increasing need for daily necessities that are hardly broken and can be continuously used. An object of the present invention is to provide a nail clipper that is one of products excellent in not only function but also durability in order to contribute to realization of a sustainable world.

### Solution to Problem

In order to solve the above problems, the present invention provides the following means. Note that in the following description, reference numerals and the like in the drawings may be added in parentheses to facilitate understanding of the invention, but each component of the present invention is not limited to these specific configurations, and should be widely interpreted to the extent that those skilled in the art can understand the invention technically.

A nail clipper according to one aspect of the present invention includes: a first blade body (10) including a first blade-edged part (13) at a first tip part (12) located at a tip portion; a second blade body (20) including a second blade-edged part (23) at a second tip part (22) located at a tip portion; and an operating member (30) for operating the first blade-edged part and the second blade-edged part to approach and separate from each other. The first tip part (12) includes a blade front (15) exposed to the outside and a blade back (16) located on the back side of the blade front. The blade back (16) is curved such that an angle with respect to a vertical direction increases with distance from a blade edge at the tip of the first blade-edged part, and an angle formed by the blade front and the blade back is 20° or more and 35° or less at the blade edge of the first blade-edged part.

In the nail clipper having the above configuration, the angle formed by the blade front and the blade back is 20° or more and 35° or less, which is an acute angle as compared with the conventional nail clipper, and a nail can be smoothly cut while reducing cutting resistance at the time of use. In addition, since the blade back is not linear but curved, and the first tip part has a shape in which the thickness thereof increases with distance from the blade edge, it is possible to suppress the warpage or breakage of the blade body. Accordingly, it is possible to provide a nail clipper having sufficient performance as a function of cutting a nail and having enhanced durability.

In the nail clipper, preferably, the angle formed by the blade front and the blade back is 27° or more and 33° or less at the blade edge of the first blade-edged part.

According to the nail clipper having the above configuration, the user can cut a nail without particular stress.

In the nail clipper, preferably, the blade back is formed to be curved in an arc shape having a radius of curvature of 5 mm or more and 50 mm or less.

According to the nail clipper having the above configuration, it is possible to have a configuration capable of sufficiently securing durability of the blade edge while making the blade edge sufficiently sharp.

In the nail clipper, preferably, the first blade body (10) further includes a first main body part (11) continuous from the first tip part (12), the first tip part (12) is bent toward the second blade body side with respect to the first main body part, the blade front (15) includes a first blade front (15a) including a blade edge and extending horizontally in the vertical direction and a second blade front (15b) continuous from the first blade front and extending linearly at an acute angle with respect to the vertical direction, and the second blade front is formed so as to form an angle of 55° or more and 75° or less with respect to the first main body part.

In conventional patent literatures and the like, there are those in which a nail clipper having a curved blade back is described, but these are merely conceptual representations in the drawings, and those adopting a shape in which the blade back is actually curved cannot be confirmed. This is because the usefulness has not been recognized for the difficulty in the manufacturing technique of curving the blade back.

This time, the inventors have found that by adopting the shape of the nail clipper in which the blade front is linear and the blade back is curved as described above, a configuration by which sufficient usefulness can be recognized even in consideration of the difficulty in the manufacturing technology can be obtained. According to the nail clipper configured as described above, it is possible to provide a nail clipper in which warpage or breakage of a blade body can be suppressed and durability is enhanced while adopting a relatively easy manufacturing technique.

In addition, according to the study of the inventors, it has been found that when the angle of the second blade front with respect to the first main body part is smaller than 55°, the thickness of the blade edge is reduced, so that the rigidity is reduced, and the blade edge is warped at the time of use, so that it is difficult to cut a nail. In addition, it has been found that when the angle of the second blade front is larger than 75°, it is difficult to shape the blade edge by press working. Therefore, by adopting the above configuration in which the angle of the second blade front with respect to the first main body part is 55° or more and 75° or less, it is possible to have a configuration in which a nail is easily cut and there is no problem even at the time of shaping.

Furthermore, by horizontally extending the first blade front in the vertical direction as described above, blade edging can be simultaneously performed on the first blade body and the second blade body, and efficiency in a manufacturing process is improved. In addition, a nail can be easily cut when the nail clipper is used.

In the nail clipper, preferably, the first blade body further includes a first main body part continuous from the first tip part, the first tip part is bent toward the second blade body side with respect to the first main body, and a blade-back connecting part (16b) connecting the blade back and the first main body part is formed to be curved so as to have a radius of curvature smaller than a radius of curvature of the blade back.

According to the nail clipper having the above configuration, it is possible to have a configuration in which it is relatively easy to shape and it is possible to sufficiently suppress breakage of a bent connecting part between the first main body part and the first tip part due to stress.

### BRIEF DESCRIPTION OF DRAWINGS

FIG. 1 is a perspective view of a nail clipper.

FIG. 2 is a side view of the nail clipper in a state where blade edges are engaged.

FIG. 3 is an enlarged view of the vicinity of the blade edges of the nail clipper in the state where the blade edges are engaged.

FIG. 4 is a top view of an upper blade body.

FIG. 5 is an enlarged view of the vicinity of the blade edge of the upper blade body.

FIG. 6 is an enlarged cross-sectional view of the vicinity of a blade edge of an upper blade body according to a modification.

### DESCRIPTION OF EMBODIMENTS

A nail clipper according to an embodiment of the present invention has a feature in that a blade back is curved on an arc such that an angle with respect to a vertical direction increases with distance from a blade edge, and an angle formed by a blade front and the blade back is 20° or more and 35° or less at the blade edge.

Hereinafter, the nail clipper according to the embodiment of the present invention will be specifically described with reference to the drawings. However, the embodiment and examples described below are merely examples of the present invention, and do not limit the technical scope of the present invention. Note that in the drawings, the same components are denoted by the same reference numerals.

In the present specification, for convenience of description, on a surface of an upper blade-edged part 13 of an upper blade body 10 on a blade front side and a surface of a lower blade-edged part 23 of a lower blade body 20 on the blade front side, a direction from the upper blade body 10 side toward the lower blade body 20 side is referred to as a “vertical direction”, but the vertical direction here does not refer to a direction of gravity that changes according to the direction of a nail clipper 1.

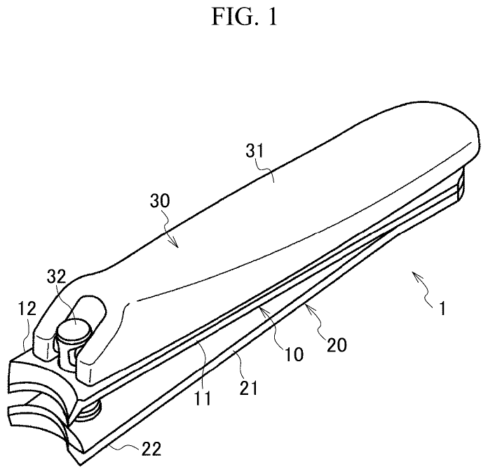

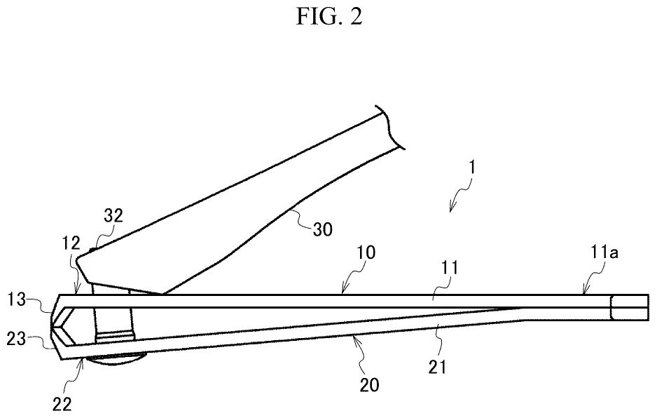

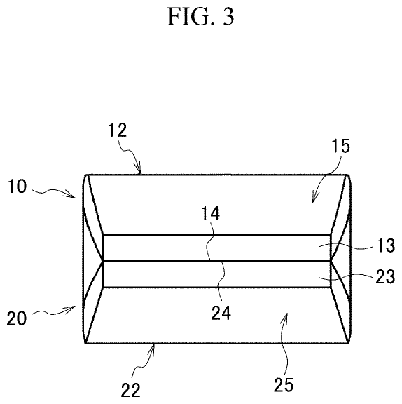

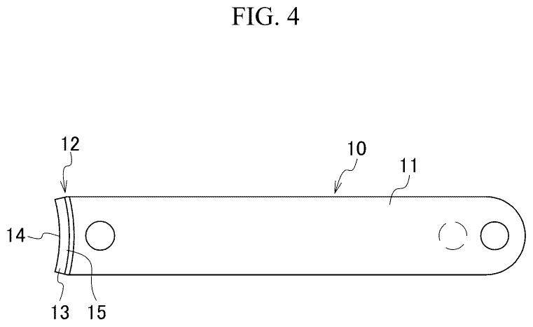

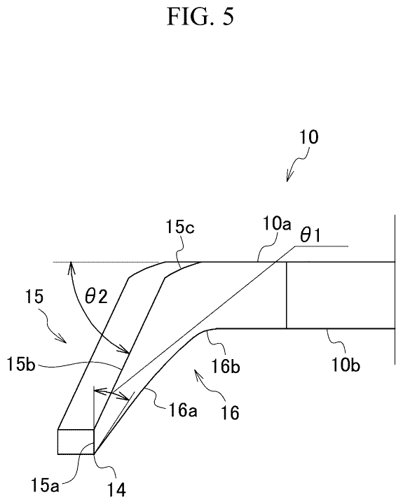

FIGS. 1 to 3 are diagrams of the nail clipper 1 of the present embodiment, in which FIG. 1 is a perspective view, FIG. 2 is a side view in a state where blade edges are engaged, and FIG. 3 is an enlarged view of the vicinity of the blade edges in the same state. FIGS. 4 and 5 are diagrams of the upper blade body 10 constituting the nail clipper 1, in which FIG. 4 is a top view, and FIG. 5 is an enlarged cross-sectional view of the vicinity of the blade edge at a central position in a width direction of the upper blade body 10.

As shown in FIGS. 1 and 2, the nail clipper 1 includes the upper blade body 10, the lower blade body 20, and an operating member 30. The operating member 30 includes a lever 31 and a support shaft 32. The upper blade body 10 and the lower blade body 20 are welded and coupled to each other at a coupling part 11a. The upper blade body 10 and the lower blade body 20 are further coupled to each other by the support shaft 32 so as to be movable in a direction in which the upper blade body 10 and the lower blade body 20 approach and separate from each other, in the vicinity of the tips of the upper blade body and the lower blade body. The support shaft 32 is a columnar member, to which the lever 31 is rotatably coupled around an axis of the support shaft 32.

As shown in FIGS. 1 to 4, the upper blade body 10 includes an upper main body part 11 and an upper tip part 12. The upper main body part 11 has a plate shape. The upper tip part 12 is formed continuously from the upper main body part 11, and is bent toward the lower blade body 20 side with respect to the upper tip part 12. The upper blade-edged part 13 that is sharpened by blade edging is formed at the upper tip part 12. The upper blade-edged part 13 has a blade edge 14 serving as the tip of the blade. The upper tip part 12 has a blade front 15 exposed to the outside and a blade back 16 located on the back side of the blade front. As shown in FIG. 4, the upper blade-edged part 13 of the upper blade body 10 is curved in an arc shape recessed at the center with respect to both ends in the width direction. The radius of curvature of the upper blade-edged part 13 is, for example, 28 mm, but may be arbitrarily changed.

As shown in an enlarged view of the upper blade body 10 in FIG. 5, the upper main body part 11 has an outer surface 10a and an inner surface 10b. The inner surface 10b is provided at a position facing a lower main body part 21 of the lower blade body 20, and the outer surface 10a is a surface opposite to the inner surface 10b.

The blade back 16 has a curved part 16a formed in a region from the blade edge 14 to a blade-back connecting part 16b, and the blade-back connecting part 16b connecting the blade back 16 and the inner surface 10b of the upper main body part 11. The curved part 16a and the blade-back connecting part 16b are curved such that an angle with respect to the vertical direction increases with distance from the blade edge 14. Specifically, the curved part 16a is curved in an arc shape, and the radius of curvature is preferably 5 mm or more and 50 mm or less, more preferably 30 mm or less, still more preferably 15 mm or less, and for example, 11.3 mm. The blade-back connecting part 16b is also curved in an arc shape, and the radius of curvature is 0.1 mm to 2.0 mm, and for example, 1.0 mm. The radius of curvature of the blade-back connecting part 16b is formed to be smaller than the radius of curvature of the curved part 16a of the blade back 16.

The blade front 15 has a first blade front 15a extending in the vertical direction from the blade edge 14, a second blade front 15b continuous from the first blade front 15a, and a third blade front 15c connecting the second blade front 15b and the outer surface 10a. The second blade front 15b extends in a direction having an acute angle with respect to the vertical direction. An angle θ2 of the second blade front 15b with respect to the outer surface 10a of the upper main body part 11 is preferably 55° or more and 75° or less, more preferably 60° or more and 70° or less, and for example, 65°. The third blade front 15c is curved in an arc shape, and the radius of curvature is 1.0 mm or more and 4.0 mm or less, and for example, 2.8 mm.

A distance L1 between the outer surface 10a and the blade edge 14 is, for example, 3.0 mm or more and 6.0 mm or less, and for example, 4.6 mm.

At the position of the blade edge 14, an angle θ1 formed by the blade front 15 and the blade back 16, more specifically, an angle formed by the first blade front 15a and the curved part 16 a is preferably 20° or more and 350 or less, more preferably 27° or more and 33° or less, and for example, 30°.

The angle θ1 formed by the blade front 15 and the blade back 16 is measured by measuring an angle formed by a tangent at a point of the tip of the blade edge 14 and the first blade front 15a of the blade front 15 in a curve formed by the blade back 16 in a cross section of the upper blade body 10.

The lower blade body 20 has substantially the same shape as the upper blade body 10, but has a slightly different shape for adjustment of engagement with the upper blade body 10, and the like.

The lower blade body 20 includes the lower main body part 21 and a lower tip part 22. The lower main body part 21 has a plate shape. The lower tip part 22 is formed continuously from the lower main body part 21, and is bent toward the upper blade body 10 side with respect to the lower main body part 21. The lower blade-edged part 23 that is sharpened by blade edging is formed at the lower tip part 22. The lower blade-edged part 23 has a blade edge 24 serving as the tip of the blade.

Here, in order to understand a difference in shape between the upper blade body 10 and the lower blade body 20, an outline of a method for manufacturing the nail clipper 1 will be described. Since a method for manufacturing a nail clipper is well known, detailed description thereof is omitted, but the nail clipper 1 is manufactured as follows.

First, blade bodies serving as base materials of the upper blade body 10 and the lower blade body 20 are prepared. The blade body serving as the base material is common to the upper blade body 10 and the lower blade body 20. Note that the shape of the blade body serving as the base material before processing is slightly different from the shapes of the upper blade body 10 and the lower blade body 20 completed through the following steps. Next, the upper blade body 10 and the lower blade body 20 are welded and coupled at the coupling part 11a. Next, the blade edges 14 and 24 are formed by performing blade edging on the respective tip portions. At this time, the front surfaces of the blade edge 14 and the blade edge 24 are formed on the same plane both before and after blade edging. Therefore, blade edging of the blade edge 14 of the upper blade body 10 and blade edging of the blade edge 24 of the lower blade body 20 can be simultaneously performed by a single blade edging process. Next, in order to slightly shift the blade edge 14 of the upper blade body 10 and the blade edge 24 of the lower blade body 20 to form a “lap” for avoiding contact between the blade edges at the time of use, the angles of the upper blade body 10 and the lower blade body 20 are adjusted by “blade broadening”.

### Use OF Nail Clipper 1

In the state of FIG. 1, the lever 31 is laid down, and in the state of FIG. 2, the lever 31 is rotated with respect to the support shaft 32 and erected. When the lever 31 is operated by the user to press the upper main body part 11 of the upper blade body 10 toward the lower main body part 21 side of the lower blade body 20 in the use state where the lever 31 is erected as shown in FIG. 2, the upper tip part 12 of the upper blade body 10 and the lower tip part 22 of the lower blade body 20 approach each other against an elastic force, and the blade edges 14 and 24 are brought into a state of being in contact with each other. Note that to be exact, the blade edges 14 and 24 are brought into a state of being slightly shifted as described above. When the user weakens the force applied to the lever 31, the upper tip part 12 of the upper blade body 10 and the lower tip part 22 of the lower blade body 20 separate from each other by the elastic force. That is, the operating member 30 is a member for operating the upper blade-edged part 13 of the upper tip part 12 and the lower blade-edged part 23 of the lower tip part 22 to approach and separate from each other.

### Modification

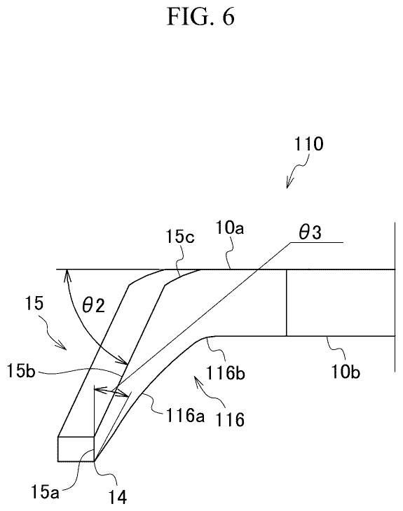

FIG. 6 is an enlarged view of the vicinity of a blade edge of an upper blade body 110 of a nail clipper according to a modification, corresponding to FIG. 5 of the embodiment. As compared with the upper blade body 10 of the embodiment, a blade back 116 of the present modification corresponding to the blade back 16 is different in the radii of curvature of a curved part 116a and a blade-back connecting part 116b and an angle formed with the blade front 15. Hereinafter, differences from the embodiment will be specifically described.

The blade back 116 has the curved part 116a formed in a region from the blade edge 14 to the blade-back connecting part 116b, and the blade-back connecting part 116b connecting the blade back 116 and the inner surface 10b of the upper main body part 11. The curved part 116a and the blade-back connecting part 116b are curved such that an angle with respect to the vertical direction increases with distance from the blade edge 14. Specifically, the curved part 116a is curved in an arc shape, and the radius of curvature is, for example, 7.6 mm. The blade-back connecting part 116b is also curved in an arc shape, and the radius of curvature is, for example, 1.0 mm.

At the position of the blade edge 14, an angle formed by the blade front 15 and the blade back 116, more specifically, an angle θ3 formed by the first blade front 15a and the curved part 116a is, for example, 25°.

The present invention is not limited to the configurations of the embodiment and the modification, and includes those modified based on the configurations of the embodiment and the modification.

### Evaluation of Nail Clipper

The nail clipper 1 of the embodiment, the nail clipper of the modification, and a nail clipper of a reference example were prepared, and actually used and evaluated by a plurality of persons. In the nail clipper of the reference example, an angle formed by a blade front and a blade back was set to 40°. Hereinafter, for convenience of description, the nail clipper 1 of the embodiment will be described as a nail clipper A, the nail clipper of the modification will be described as a nail clipper B, and the nail clipper of the reference example will be described as a nail clipper C.

The plurality of persons evaluated each of a good cutting feeling and sharpness when nails were cut in four grades of 1. Good, 2. Fair, 3. Slightly poor, and 4. Poor. As for the good cutting feeling, the cleanliness of a cut end when the nail was cut, the ease of separation of the cut nail, the occurrence of burrs, and the like were comprehensively determined. The sharpness was determined based on the degree to which the nail can be cut with a light force. Average values of the four-grade evaluation were obtained for the good cutting feeling and the sharpness. That is, the lower the value, the higher the evaluation.

As a result of the evaluation, the nail clipper A had a good cutting feeling of 1.3 and a sharpness of 2.0, the nail clipper B had a good cutting feeling of 1.4 and a sharpness of 1.6, and the nail clipper C had a good cutting feeling of 1.8 and a sharpness of 2.2. That is, the nail clipper A had the highest evaluation for the good cutting feeling, and the nail clipper B had the highest evaluation for the sharpness. From these evaluation results, it has been found that although the sharpness of the nail clipper B is the highest, the user will generally like the nail clipper A.

### Features of Nail Clipper

In the nail clippers according to the embodiment and the modification as described above, the blade back 16 is curved such that the angle with respect to the vertical direction increases with distance from the blade edge 14 at the tip of the upper blade-edged part 13, and the angle formed by the blade front 15 and the blade back 16 is 20° or more and 35° or less at the blade edge 14 of the upper blade-edged part 13. With such a configuration, it is possible to smoothly cut a nail while reducing cutting resistance at the time of use. In addition, since the blade back 16 is not linear but curved, and the upper tip part 12 has a shape in which the thickness thereof increases with distance from the blade edge 14, it is possible to suppress the warpage or breakage of the upper blade body 10. Accordingly, it is possible to provide a nail clipper having sufficient performance as a function of cutting a nail and having enhanced durability.

In addition, since the angle formed by the blade front 15 and the blade back 16 is set to 27° or more and 33° or less, the user can cut a nail without particular stress.

In addition, since the blade back 16 is formed to be curved in an arc shape having a radius of curvature of 5 mm or more and 50 mm or less, it is possible to have a configuration capable of sufficiently securing durability of the blade edge 14 while making the blade edge 14 sufficiently sharp.

In addition, in the upper blade body 10, the upper tip part 12 is bent toward the lower blade body 20 side with respect to the upper main body part 11. In the blade front 15, the second blade front 15b continuous from the first blade front 15a including the blade edge 14 and horizontally extending in the vertical direction, and linearly extending at an acute angle with respect to the vertical direction is formed to form an angle 02 of 55°or more and 75°or less with respect to the upper main body part 11. With such a configuration, it is possible to provide a nail clipper in which warpage or breakage of a blade body can be suppressed and durability is enhanced while adopting a relatively easy manufacturing technique.

In addition, since the blade-back connecting part 16b is formed to be curved so as to have a radius of curvature smaller than the radius of curvature of the curved part 16a of the blade back 16, it is relatively easy to shape, and it is possible to sufficiently suppress breakage of a bent connecting part between the upper main body part 11 and the upper tip part 12 due to stress.

Note that as described in the embodiment, each of the above configurations is applied not only to the upper blade body 10 but also to the lower blade body 20, and it is more preferable that the upper blade body 10 and the lower blade body 20 have the above configurations.

However, even when the above configurations are adopted only for the upper blade body 10 or the lower blade body 20, a certain effect can be obtained.

### REFERENCE SIGNS LIST

1 Nail clipper
10, 110 Upper blade body
11 Upper main body part
12 Upper tip part
13 Upper blade-edged part
14 Blade edge
15 Blade front
16, 116 Blade back
16a, 116a Curved part
16b, 116b Blade-back connecting part
20 Lower blade body
21 Lower main body part
22 Lower tip part
23 Lower blade-edged part
24 Blade edge
30 Operating member
31 Lever
32 Support shaft

1. A nail clipper comprising:
a first blade body including a first blade-edged part at a first tip part located at a tip portion;
a second blade body including a second blade-edged part at a second tip part located at a tip portion; and
an operating member for operating the first blade-edged part and the second blade-edged part to approach and separate from each other, wherein
the first tip part includes a blade front exposed to the outside and a blade back located on a back side of the blade front, the blade back is curved such that an angle with respect to a vertical direction increases with distance from a blade edge at a tip of the first blade-edged part,
the blade front includes a first blade front including the blade edge and extending horizontally in the vertical direction, and
an angle formed by the blade front and the blade back is 20° or more and 35° or less at the blade edge of the first blade-edged part.

2. The nail clipper according to claim 1, wherein
the angle formed by the blade front and the blade back is 27° or more and 33° or less at the blade edge of the first blade-edged part.

3. The nail clipper according to claim 1, wherein
the blade back is formed to be curved in an arc shape having a radius of curvature of 5 mm or more and 50 mm or less.

4. The nail clipper according to claim 1, wherein
the first blade body further includes a first main body part continuous from the first tip part,
the first tip part is bent toward the second blade body side with respect to the first main body part,
the blade front includes a second blade front continuous from the first blade front and extending linearly at an acute angle with respect to the vertical direction, and
the second blade front is formed so as to form an angle of 55° or more and 75° or less with respect to the first main body part.

5. The nail clipper according to claim 1, wherein
the first blade body further includes a first main body part continuous from the first tip part,
the first tip part is bent toward the second blade body side with respect to the first main body part, and
a blade-back connecting part connecting the blade back and the first main body part is formed to be curved so as to have a radius of curvature smaller than a radius of curvature of the blade back.
